(19) United States
(12) Patent Application Publication
(10) Pub. No.: US 2022/0243083 A1
(43) Pub. Date: Aug. 4, 2022

(54) AQUEOUS MONODISPERSE STARCH-GOLD NANOPARTICLES AND PROCESS FOR PRODUCING THE SAME

(71) Applicant: ATENEO DE MANILA UNIVERSITY, Quezon City (PH)

(72) Inventors: Erwin Enriquez, Quezon City (PH); Nikita P. Bacalzo, Quezon City (PH)

(21) Appl. No.: 17/429,026

(22) PCT Filed: Feb. 7, 2020
(86) PCT No.: PCT/PH2020/050001

§ 371 Date: Aug. 6, 2021

(30) Foreign Application Priority Data
Feb. 7, 2019 (PH) 12019000076

(51) Int. Cl. C09D 11/50; C09D 11/037; C09D 11/033; C09D 11/14; C09D 11/322; H01B 1/16; B41M 5/00

(52) U.S. Cl. CPC C09D 11/50; C09D 11/037; C09D 11/033; B41M 5/0023; C09D 11/322; H01B 1/16; C09D 11/14

(57) ABSTRACT

A process for making a conductive ink formulation for jet-printing which uses a fine-tuned molecular weight of hydrolyzed starch particles and using microwave-assisted synthesis to produce a stable, monodisperse, aqueous-based gold ink formulation. This aqueous ink formulation is shown to be highly jettable and forms films which sinter at relatively low temperatures. Printed gold film using the formulation can achieve <1.0 Ω/square sheet resistance upon drying for about 30 minutes and sinters at 200° C. thereby improving its conductivity.

### TECHNICAL FIELD OF THE INVENTION

The present invention relates in general to starch-stabilized gold nanoparticle aqueous dispersion with a narrow range of hydrolyzed starch and narrow size distribution of the gold nanoparticles. More specifically, the present invention relates to a novel process for synthesis and formulation of starch-stabilized gold nanoparticles and their dispersion in water, wherein the concentrated dispersion produces a dried film by ink-jet printing or related printing techniques, and that is highly conducting and that sinters at low temperature to increase its conductivity. According to the present invention, a specific range of molecular weights of hydrolyzed starch yields a stable starch-gold nanoparticle dispersion with a low starch-to-gold mass ratio and a monodisperse size distribution of the gold nanoparticles.

### BACKGROUND OF THE INVENTION

Printed electronics is one of the recent advances in manufacturing various electronic devices where in inkjet printing, the material is only deposited on specific areas on the substrate thus saving on cost of materials [Kang, J. S.; Kim, H. S.; Ryu, J.; Thomas Hahn, H.; Jang, S.; Joung, J. W. J., Mater. Sci. Mater. Electron. 2010, 21 (11), 1213-1220]. Inkjet printing has been employed to print conductive patterns made from metallic electrodes such as silver and gold [Cui, W.; Lu, W.; Zhang, Y.; Lin, G.; Wei, T.; Jiang, L., Colloids Surfaces A Physicochem. Eng. Asp. 2010, 358 (1-3), 35-41; Jensen, G. C.; Krause, C. E.; Sotzing, G.; Rusling, J. F., Phys. Chem. Chem. Phys. 2011, 13 (11), 4888-4894; Volkman, S. K.; Yin, S.; Subramanian, V. Mater. Res. Soc. Proc. 2004, 814, 17.8]. A major component in inkjet printing technology is the ink formulation that will be jetted through the nozzle into single isolated droplets. Jettable inks can be formulated by varying its fluid properties, specifically the surface tension, density and viscosity. A common criterion for jettability of inks is determined by the dimensionless parameter called Z-number, which is the reciprocal of the Ohnesorge number [Ohnesorge, W. V. J. Appl. Math. Mech. 1936, 16 (6), 355-358]. This parameter relates the viscous forces of the fluid to its inertial and surface tension forces, as shown in the equation below,

Z=(σρd)^{1/2}/η (Eq. 1)

where σ is surface tension, ρ is density, and η is viscosity of the ink, while d is the nozzle diameter. However, several Z-number ranges (e. g., 1<Z<10 or 4≤Z≤14)18 have been reported by different authors for the jettability window. Hence, some studies have actually defined the jettability regime for inks using various two-parameter plots [Kim, E.; Baek, J. Model. Phys. Fluids 2012, 24 (8)]. For example, in the study by Subramanian et al., a jettable ink formulation is empirically defined within regions bounded by the capillary and Weber (Ca-We) number space, highlighting the effects of inertial and viscous forces normalized by surface tension of the ink formulation; these regions appear to be universal for jettable ink formulations that produce satellite-free droplets [Nallan, H. C.; Sadie, J. A.; Kitsomboonloha, R.; Volkman, S. K.; Subramanian, V. Langmuir 2014, 30, 13470-13477].

For printing the metallic electrodes like silver and gold, the inks are either colloidal suspension of their nanoparticles or salt precursor solutions which can be post-processed to achieve the desired conductive metal [Määttänen, A.; Ihalainen, P.; Pulkkinen, P.; Wang, S.; Tenhu, H. J.; Peltonen, ACS Appl. Mater. Interfaces 2012, 4 (2) 955-964; Huang, D.; Liao, F.; Molesa, S.; Redinger, D.; Subramanian, V. J. Electrochem. Soc. 2003, 150 (7), G412; Kosmala, A.; Zhang, Q.; Wright, R.; Kirby, P., Mater. Chem. Phys. 2012, 132 (2-3), 788-795; Shen, W.; Zhang, X.; Huang, Q.; Xu, Q.; Song, W., Nanoscale 2014, 6, 1622-1628; Perelaer, J.; de Laat, A. W. M.; Hendriks, C. E.; Schubert, U. S., J. Mater. Chem. 2008, 18 (27), 3209; Jahn, S. F.; Blaudeck, T.; Baumann, R. R.; Jakob, A.; Ecorchard, P.; Rüffer, T.; Lang, H.; Schmidt, P., Chem. Mater. 2010, 22; Magdassi, S.; Kamyshny, A; Vinetsky, Y; Bassa, A.; Mokh, R. A., US 2005/0078158A1]. In ink formulations of metal nanoparticle suspensions, aside from jettability, size and stability are also important factors to consider. The nanoparticles are usually stabilized with a capping agent which gives a very stable dispersion on the selected solvent, which is usually nonpolar. In the case of gold nanoparticles (AuNP), it is commonly synthesized using the Brust process which is a two-phase synthesis with NaBH₄ as the reducing agent and alkanethiols, or surfactants, as the capping agent [Cortie, M. B.; Coutts, M. J.; Ton-That, C.; Dowd, A.; Keast, V. J.; McDonagh, A. M., J. Phys. Chem. C 2013, 117 (21), 11377-11384]. Since the capping agents usually have nonpolar groups, it is suspended in a mixture of organic solvents. Greener approach to AuNP synthesis has also been a trend wherein more environmentally-benign reducing agents and stabilizing ligands are used in the synthesis. There are already many studies which explored green synthesis of silver and gold nanoparticles using plant extracts [Elia, P.; Zach, R.; Hazan, S.; Kolusheva, S.; Porat, E.; Zeiri, Y. Int. J. Nanomedicine 2014, 9, 4007-4021; Ovais, M.; Raza, A.; Naz, S.; Islam, N. U.; Khalil, A. T.; Ali, S.; Khan, M. A.; Shinwari, Z. K. Appl. Microbiol. Biotechnol. 2017, 101 (9), 3551-3565; Dauthal, P.; Mukhopadhyay, M., 3 Biotech 2016, 6 (2), 1-9; Godipurge, S. S.; Yallappa, S.; Biradar, N. J.; Biradar, J. S.; Dhananjaya, B. L.; Hegde, G.; Jagadish, K.; Hegde, G. A., Enzyme Microb. Technol. 2016, 95, 174-184], natural polymers [Ban, D. K.; Pratihar, S. K.; Paul, S. RSC Adv. 2015, 5 (99), 81554-81564; Pooja, D.; Panyaram, S.; Kulhari, H.; Reddy, B.; Rachamalla, S. S.; Sistla, R. Int. J. Biol. Macromol. 2015, 80, 48-56.], and other alternatives to nonpolar ligands and solvents [Cui, W.; Lu, W.; Zhang, Y.; Lin, G.; Wei, T.; Jiang, L. Colloids Surfaces A Physicochem. Eng. Asp. 2010, 358 (1-3), 35-41; Zeng, S.; Du, L.; Huang, M.; Feng, J. X. Bioprocess Biosyst. Eng. 2016, 39 (5), 785-792; Liu, J.; Qin, G.; Raveendran, P.; Ikushima, Y. Chem.—A Eur. J. 2006, 12 (8), 2131-2138].

Of special interest is the use of starch as both the reducing and stabilizing agent for gold nanoparticles (AuNPs) [Vantasin, S.; Pienpinijtham, P.; Wongravee, K.; Thammacharoen, C.; Ekgasit, S. Sensors Actuators, B Chem. 2013, 177, 131-137; Tajammul Hussain, S.; Iqbal, M.; Mazhar, M. J. Nanoparticle Res. 2009, 11 (6), 1383-1391; Engelbrekt, C.; Sorensen, K. H.; Zhang, J.; Welinder, A. C.; Jensen, P. S.; Ulstrup, J., J. Mater. Chem. 2009, 19, 7839; Raveendran, P.; Fu, J.; Wallen, S. L. Green Chem. 2006, 8 (1), 34]. Microwave-assisted synthesis and hydrolysis had been reported in the synthesis of these nanoparticles [Pienpinijtham, P.; Thammacharoen, C.; Ekgasit, S. Macromol. Res. 2012, 20 (12), 1281-1288; Arshi, N.; Ahmed, F.; Kumar, S.; Anwar, M. S.; Lu, J.; Koo, B. H.; Lee, C. G. Curr. Appl. Phys. 2011, 11, S360-S363; Rastogi, L.; Arunachalam, J. Int. J. Green Nanotechnol. 2012, 4 (2), 163-173; Kundu, S.; Peng, L.; Liang, H. Inorg. Chem. 2008, 47 (14), 6344-6352].

However, none of these documents known in the art provide the teaching according to the present invention, wherein the starch solution is hydrolyzed by microwave-assisted heating in NaOH solution to activate its reducing ends. This will in turn reduce the Au ions in the solution to Au(0) wherein an optimized molecular weight range of hydrolyzed starch molecules stabilize the nanoparticles to control its further growth. Size-controlled and stable AuNP dispersions are then produced from this technique without the use of nonpolar ligands and solvents.

### SUMMARY AND OBJECTS OF THE INVENTION

The present invention relates in general to starch-stabilized gold nanoparticle aqueous dispersion with a narrow range of hydrolyzed starch and narrow size distribution of the gold nanoparticles. More specifically, the present invention relates to a novel process for synthesis and formulation of starch-stabilized gold nanoparticles and their dispersion in water, wherein the concentrated dispersion produces a dried film by ink-jet printing or related printing techniques, and that is highly conducting and that sinters at low temperature to increase its conductivity. According to the present invention, a specific range of molecular weights of hydrolyzed starch yields a stable starch-gold nanoparticle dispersion with a low starch-to-gold mass ratio and a monodisperse size distribution of the gold nanoparticles.

The primary object of this invention is to provide an aqueous AuNP ink formulation that uses an optimally hydrolyzed starch, obtained through microwave-assisted heating that controls the size and reducing capacity of said optimally hydrolyzed starch.

It is also the object of this invention to provide an aqueous AuNP ink formulation that uses an optimally hydrolyzed starch, obtained through microwave-assisted heating, as both the reducing and stabilizing agent in the microwave synthesis of the AuNP nanoparticles.

Still another object of this invention is to provide an aqueous AuNP ink formulation that can be used in inkjet printing for printed electronics applications, as alternative to commercial AuNP ink formulations that are organic-solvent based.

Yet another object of this invention is to provide a process for optimized synthesis of AuNP based on the particle size, stability, and yield by varying the starch hydrolysis conditions carried out by microwave-assisted hydrolysis and reaction, in which the microwave-assisted heating provides more uniform heating to the reaction mixture.

Furthermore, it is another object of the present invention to provide a process for an optimized AuNP synthesis reaction using microwave-assisted heating to yield a narrow, monodisperse size distribution of AuNP resulting to printed Au films having low sheet resistance (<1.0 Ω/square) even at low sintering temperatures (ca. 200° C.).

These and other objects will become apparent upon reading the following detailed description taken in conjunction with the accompanying drawings.

### BRIEF DESCRIPTION OF THE DRAWINGS

FIG. 1 is a diagram showing the summary of this invention wherein microwave heating is used for both the controlled starch hydrolysis and AuNP synthesis. The synthesized AuNP solution is then used for inkjet printing of conductive patterns.

FIG. 2 shows the characterization data of the hydrolyzed starch and monodisperse starch-AuNP solution according to the present invention showing: (a) Particle size (PS) and molecular weight (MW) of starch hydrolyzed at different temperatures and time periods, and properties of AuNP solutions synthesized using various hydrolyzed starches: (b) UV-Vis characterization, (c) PS and polydispersity index (PdI), and (d) zeta potential measured using dynamic light scattering (DLS) technique.

FIG. 3 demonstrates the thermal property of dried AuNP ink (black) and starch (blue) analyzed by thermogravimetry at 10° C./min rate. Onset degradation temperatures are approximated from the graph as indicated.

FIG. 4 shows the jettability and printability of the ink and AuNP size distribution. (a) Satellite-free, single droplets (approximately 60 μm in diameter) of AuNP ink were formed using a DoD programmable inkjet printer system. (b) Photograph of gold lines printed on PEN, a flexible substrate. Inset: Micrograph of printed line. (c) Particle size distribution measured using SAXS in transmission mode. Inset: Raw scattering intensity at small-angle and fitted model for particle size analysis.

FIG. 5 shows morphology of the Au films imaged using AFM (top) and FESEM (bottom). (a) and (c) correspond to film heated at only 50° C., while images (b) and (d) correspond to the film heated at 400° C. Scale bars correspond to 200 nm.

FIG. 6 is a characterization of printed gold. (a) In situ XRD measurement of the gold film at various heating temperatures as indicated. (b) Left axis & colored markers: Sheet resistance values of the gold film measured after heating at various temperatures. Right axis & black markers: Crystallite size derived from Au(111) using Scherrer equation at various temperatures. Graph was shaded to emphasize the two regions discussed in the text and the transition at about 200° C.

FIG. 7 is surface-enhanced IR absorption spectra of AuNP ink dried and heated at various temperatures as indicated.

FIG. 8 shows the sample printing parameter and printed film using the starch-AuNP formulation. (a) Bipolar voltage waveform that was applied to the piezoelectric inkjet nozzle to produce single drops from the as-synthesized AuNP ink. The first and last segment correspond to the rise and fall times, respectively, both set at 2 μs; setting the echo time to 4.5 times the dwell time was optimal for our aqueous-based ink. (b) Microscope image of gold lines printed with as-synthesized AuNP ink. (c) Photograph of printed square pattern of gold film used to measure sheet resistance values.

### DETAILED DESCRIPTION

The present invention relates in general to starch-stabilized gold nanoparticle aqueous dispersion with a narrow range of hydrolyzed starch and narrow size distribution of the gold nanoparticles. More specifically, the present invention relates to a novel process for synthesis and formulation of starch-stabilized gold nanoparticles and their dispersion in water, wherein the concentrated dispersion produces a dried film by ink-jet printing or related printing techniques, and that is highly conducting and that sinters at low temperature to increase its conductivity. According to the present invention, a specific range of molecular weights of hydrolyzed starch yields a stable starch-gold nanoparticle dispersion with a low starch-to-gold mass ratio and a monodisperse size distribution of the gold nanoparticles.

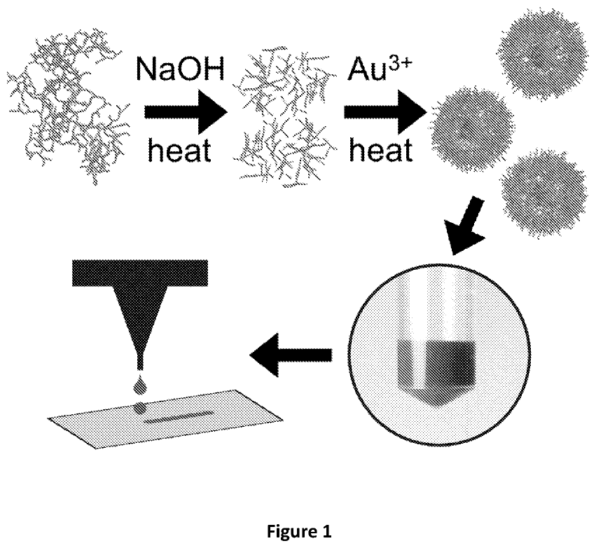

The new approach to aqueous AuNP ink formulation according to the present invention uses an optimally hydrolyzed starch by microwave-assisted heating (to control size and reducing capacity) and using such as both the reducing and stabilizing agent in the subsequent microwave synthesis of the AuNP nanoparticles. The ink formulation according to the present invention can be used in inkjet printing, in relation to application in printed electronics, as alternative to most commercial AuNP ink formulations that are organic-solvent based (FIG. 1). The synthesis of AuNP was optimized based on the particle size, stability, and yield by varying the starch hydrolysis conditions carried out by microwave-assisted hydrolysis and reaction in which the microwave-assisted heating provides more uniform heating to the reaction mixture. Microwave-assisted heating was also used in the AuNP synthesis reaction to yield a narrow, monodisperse size distribution of AuNP. After optimizing the synthesis of the AuNP ink, the ink was printed on solid substrates and the subsequently dried film was characterized for electrical conductivity including its sintered film. It is demonstrated that the printed Au films have low sheet resistance (<1.0 Ω/square) even at low sintering temperatures (ca. 200° C.). Such conductivity is comparable to other formulation of AuNP inks.

### 1. Microwave-Assisted Hydrolysis of Starch to Control Molecular Weight

The approach by Ekgasit et al. [Pienpinijtham, P.; Thammacharoen, C.; Ekgasit, S. Macromol. Res. 2012, 20 (12), 1281-1288; Arshi, N.] uses hydrolyzed starch for the reduction of Au³⁺ to Au⁰, wherein they proposed that the hydrolysis of starch under mild alkaline conditions produces intermediates containing either an aldehyde or a-hydroxy ketone, which can reduce Au³⁺, and subsequently be oxidized into their carboxylic acid form. The present invention modifies and optimizes such process through microwave-assisted heating to control the molecular weight size range of the final hydrolyzed starch which is shown to affect the resulting size and distribution of the AuNP. Microwave reactor was used to control the temperature of the starch hydrolysis and the resulting solutions were characterized for its Z-average particle size (PS) using dynamic light scattering (DLS) and weight-average molecular weight (MW) using the same instrument in static light scattering (SLS) mode. The Z-average particle size is also called harmonic intensity-weighted arithmetic average particle diameter, whereas the weight-average MW is derived from the Debye plot of the scattering intensity of the starch solution with respect to its concentration.

Optimization aims to maximize the yield, minimize the size, and maximize the stability of the resulting AuNP ink from the synthesis process in this invention. To do this, the amount of the reducing species from the hydrolyzed starch was varied by changing the microwave-assisted hydrolysis conditions, i.e., temperature (70, 80, 90° C.) and time (15, 30, 45 min), using a microwave reactor. By maximizing the yield and minimizing the size of the gold nanoparticles, the final loading of the AuNP in the ink will be greater. This can contribute to increased conductivity of the printed gold patterns due to tight-packing of smaller particles. The ratio of starch-to-gold is also further optimized to increase the concentration of AuNP in the ink formulation for the target printed electronics application.

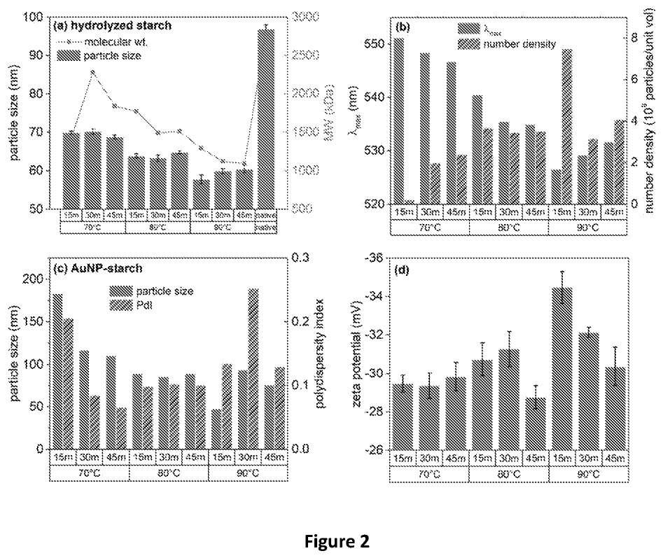

FIG. 2A shows the effect of the hydrolysis temperature and time on the MW and PS of the starch, wherein both parameters significantly decreased compared with an unhydrolyzed sample (labelled as “native”). The MW and Z-average size of the starch decreased by as much as 2× upon heating at 90° C. There is clear trend that increasing the hydrolysis temperature yielded lower MW and smaller size regardless of the time of heating investigated (15-45 min). This trend is expected since elevated temperature increases the rate of the starch degradation, generating smaller chains of the polymer [Pineda-Goímez, P.; Rosales-Rivera, A.; Rodríguez-García, M. E. Starch 2012, 64 (10), 776-785; Krochta, J. M.; Hudson, J. S.; Tillin, S. J. Prepr. Pap., Am. Chem. Soc., Div. Fuel Chem. 1987, 32, 148-156.]. The time of hydrolysis (15-45 minutes), at the temperatures tested, did not have significant effect on both MW and particle size.

### 2. Synthesis of AuNP Using Controlled Hydrolysis of Starch by Microwave Heating

The microwave-hydrolyzed starch samples obtained from the process previously described are used to synthesize AuNP using the process as described in the examples; typically mixing equal volumes of the hydrolyzed starch (4% w/v) and an AuNP precursor solution prepared from 0.1 M HAuCl₄ solution, adjusted to pH 7 by NaOH and then heating again in the microwave reactor for 5 min. Here, the concentration of the precursor Au³⁺ in the final reaction mixture may be fixed to 25.0 mM, which is a rather high concentration compared with other reported synthesis processs, typically 1.0-12.5 mM.

The resulting AuNP solutions from the examples were characterized by UV-Vis spectroscopy (FIG. 2B) and DLS (FIGS. 2C, 2D). The surface plasmon resonance (SPR) peak of AuNP is related to its size and concentration. Larger AuNP shifts the wavelength of maximum absorbance (λₘₐₓ) to higher values, whereas the peak width corresponds to the size distribution of the AuNP sample. Moreover, higher absorbance value indicates a more concentrated sample.

Increased starch hydrolysis temperature from step 1, e.g., 70° C. to 90° C. resulted in blue-shifted SPR peak of the synthesized AuNP from 550 to 530 nm (FIG. 2B), which signifies significant decrease in the AuNP particle size. Elevated starch hydrolysis temperature generates more reducing species and therefore increases the reductant-to-Au³⁺ ratio in the AuNP synthesis reaction.

The trend in particle size observed in the UV-Vis spectra was also confirmed with the Z-average particle size measurement using DLS, where there was a decrease in the particle size of the AuNP-starch nanoparticles from about 175 nm to about 50 nm with increased heating temperature from 70° C. to 90° C. (FIG. 2C). Also, the number density of the AuNP particles was estimated from the UV-Vis spectra using a formula (Eq. 2) reported by Haiss et al. [Haiss, W.; Thanh, N. T. K.; Aveyard, J.; Fernig, D. G., Anal. Chem. 2007, 79 (11), 4215-4221.] It was calculated that higher number density of AuNP was achieved at elevated hydrolysis temperature, as expected with the observed trend for the AuNP size. Since the initial concentration of Au³⁺ is equal in all samples, a higher AuNP concentration should be expected for sample with smaller AuNP size than with a larger one.

Another value derived from the cumulants analysis of the DLS data is the polydispersity index (PdI), which is a dimensionless number indicating the broadness of the size distribution around Z-average size. It ranges from 0.0 to 1.0 with 1.0 being the most polydisperse. In the case of the synthesized AuNP samples in this study, PdI values range from 0.07-0.25, which indicate relatively narrow size distributions of AuNP. No obvious trend was observed for PdI value with respect to the starch hydrolysis time and temperature (FIG. 2C). However, the UV-Vis spectra of the AuNP samples showed decreasing peak width of the SPR as the hydrolysis temperature increased from 70 to 90° C., indicating that starch hydrolyzed at higher temperature produced a more monodisperse AuNP. The apparent discrepancy between DLS and UV-Vis trend in the size distribution can be explained by noting that DLS measurements is based on hydrodynamic particle size, which is defined as the size of a hard sphere that diffuses at the same speed as the particle being measured. This is affected by various factors such as the surface properties of the particle, the nature of the dispersant, and its ionic concentration. On the other hand, UV-Vis size measurement is based on the SPR phenomenon which is related to the actual size of the plasmonic nanoparticle.

Zeta potentials of the AuNP samples were also measured (FIG. 2D). This parameter indicates the long-term stability of the colloidal suspension, for which a value of |ζ|>30 mV is generally desirable. Higher |ζ| values were measured for AuNP samples synthesized using starch hydrolyzed at higher temperature, signifying more stable AuNP sample. The resulting optimized ink formulation (see below) remains stable for several months (with no observed flocculation) at ca. 4° C. refrigerator storage. Since smaller starch coils are formed at elevated temperatures, more can bind with the AuNPs during the reduction of Au³⁺. These starch molecules are oxidized to form carboxylate or OH— end groups that contribute to the surface charge such as what was reported for the case of β-D-glucose reduction of Au³⁺. It is noted that hydrolysis time (for the present range tested) had no significant effect on the zeta potential just like for the case of starch MW and size.

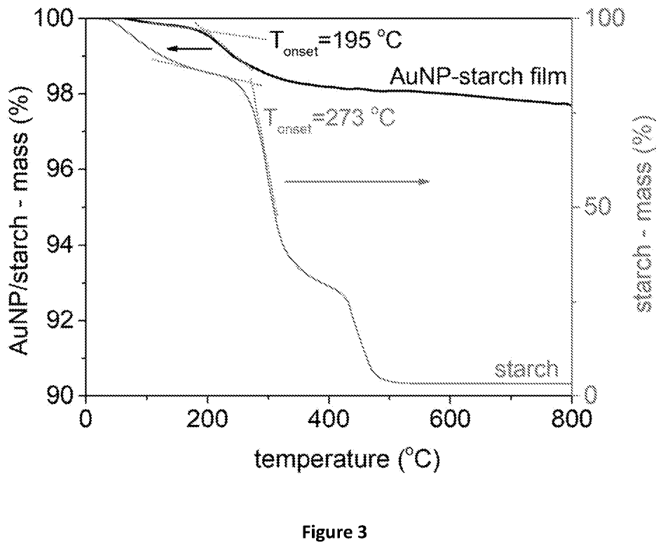

It is also noted that the starch-to-gold ratio is quite low in the synthesized AuNP dispersion, which is less than 2 wt % (FIG. 3). The only found prior literature on aqueous gold ink formulation is synthesized using poly(N-vinylpyrrolidone) (PVP) and acrylic resin (AR) as stabilizers. This had as much as 57 wt % polymer in the final printed material based on their TGA data, and needs to be burned off at 500° C. to achieve a highly conductive print [Cui, W.; Lu, W.; Zhang, Y.; Lin, G.; Wei, T.; Jiang, L. Colloids Surfaces A Physicochem. Eng. Asp. 2010, 358 (1-3), 35-41]. As shown and discussed below, the ink formulation according to the present invention, with low starch loading already forms a highly conductive ink even by just drying at 50° C.; and it has an advantage as it can sinter at a much lower temperature of about 200° C. to burn off the starch in the printed material, resulting to increased conductivity.

### 3. Jettability and Printability of Optimized AuNP-Starch Ink

The synthesized AuNP ink obtained from the process described above can be printed using a drop-on-demand (DoD) inkjet printer. As previously mentioned, the jettability of an ink can be predicted by gauging its fluid properties such as viscosity, surface tension, and density.

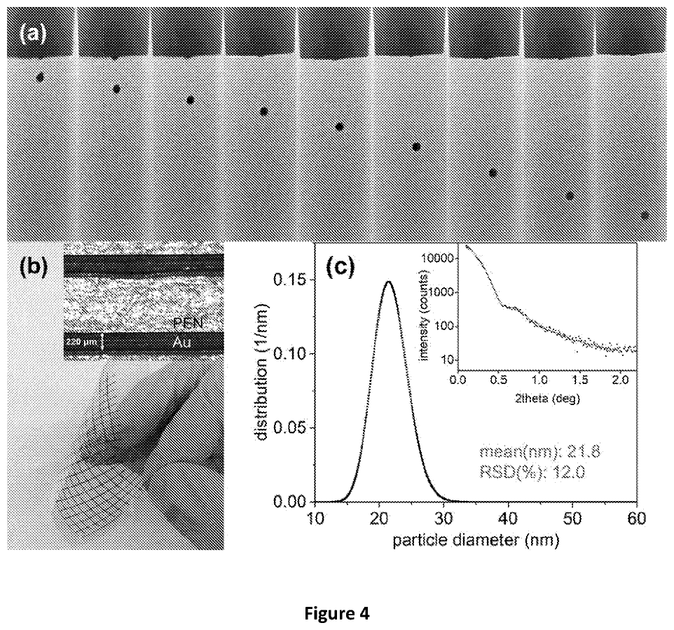

For the ink obtained from the above-discussed process and the examples below, viscosity is approximately measured to be 1.20 cP, surface tension is 69.7 mN/m, and the density is 1.0246 g/mL; using Eq. 1, Z-number for this ink is 54.6. This is beyond the range set by most studies on inkjet printing. However, as discussed and demonstrated by Subramanian et al., there are inconsistencies regarding jettability criteria using Z-number [Nallan, H. C.; Sadie, J. A.; Kitsomboonloha, R.; Volkman, S. K.; Subramanian, V. Langmuir 2014, 30, 13470-13477.]. In any case, the resulting ink was successfully jetted to single drops without satellite droplets as shown in the FIG. 4A. A bipolar voltage waveform was applied to a 60-μm diameter inkjet nozzle and the substrate (cleaned glass slides were used for most sintering characterizations) was heated at 50° C. during the printing. In printing isolated single lines, coffee-ring effect may be observed in the as-synthesized AuNP ink, but it can be suppressed by adding a minimal amount of surfactant (˜0.3% w/w Triton X-100), if it could not be suppressed by changing the drop spacing and printing speed alone. Adding surfactant changed the Z-number of the resulting ink to around 37.2 since the surface tension of the ink significantly decreased and it was still jetted to single drops. A sample grid pattern was printed on polyethylene naphthalate (PEN) substrate and a zoomed-in image of the printed lines is shown in FIG. 4B. For printing of solid square patterns, the as-synthesized ink was used without the added surfactant since the close spacing of the lines will make up for the hollow space left by the coffee ring effect. The square patterns were used to measure sheet resistance values. Thickness of the printed gold films were approximated by extracting line profiles from atomic force microscope images, generally showing ˜100 nm for a single layer print.

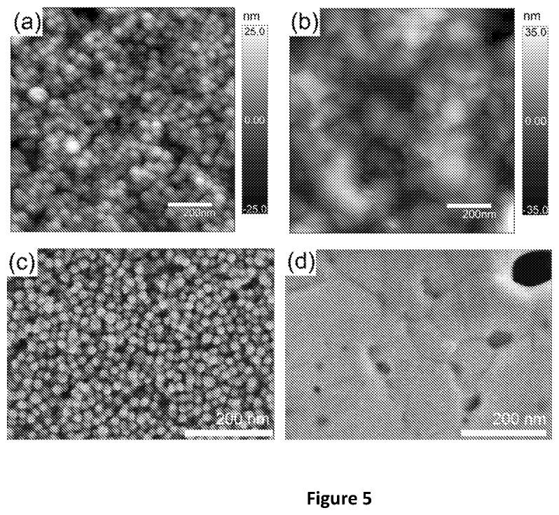

Small angle X-ray scattering (SAXS) in transmission mode was done to measure the particle size in the ink (FIG. 4C). The difference between this process and that of DLS technique is the concentration of AuNP in the sample. In the SAXS measurement, the actual ink concentration was measured, while the DLS requires dilute sample. A Gaussian particle size distribution was fitted to the SAXS data which gave average size of 21.8 nm±12%. This tolerance value is similar to some commercially-available standards of gold nanoparticle suspension, indicating the advantage of using microwave heating in nanoparticle synthesis. The average particle size from SAXS is smaller from the one measured in DLS because, as pointed out before, the DLS considers the hydrodynamic size of the particle. This particle size was verified from the AFM and SEM images (FIG. 5). Furthermore, compared with the β-D-glucose-reduced AuNP solution which yielded 28% RSD (mean size of 8.2 nm based on TEM) [Liu, J.; Qin, G.; Raveendran, P.; Ikushima, Y. Chem.—A Eur. J. 2006, 12 (8), 2131-2138.] the monodisperse AuNP dispersion according to the present invention is at 12% RSD albeit at a larger mean size.

### 4. Sintering Behavior of the AuNP Ink as a Function of Temperature

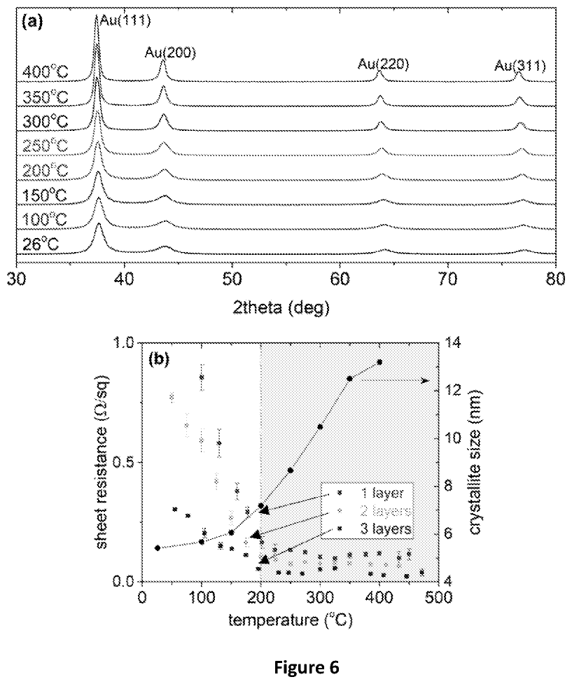

Inkjet-printed films obtained using the ink from the above-described process, as well as the examples, were characterized for their electrical property by measuring the sheet resistance upon drying and heating to reach the sintering temperature. The trend in conductivity (FIG. 6B) coincides with changes in the particle morphology as manifested in broadening of the XRD peaks of the gold crystallites (FIG. 6A). At temperatures below 200° C., linear decreasing trend in sheet resistance was observed for all the printed film samples, while at temperatures above 200° C., the sheet resistance values remained relatively constant (˜0.12 Ω/square for one-layer, ˜0.08 Ω/square for two-layer, ˜0.04 Ω/square for three-layer). It is noted that the film with three layers of the ink printed on it has the lowest sheet resistance across the temperature values measured, followed by the two-layer print and then the one-layer print which has the highest sheet resistance. This trend is expected as more nanoparticles deposited on the film increases the chance for the formation of electron conduction network. Thus, the printed Au film should be heated to at least 200° C. to achieve its best performance as a conductor. Nonetheless, heating it at lower than 200° C. still makes it conductive with relatively low sheet resistance (<1.0 Ω/square), and this may be used for flexible plastic substrates. This value is comparable to sheet resistance values of evaporated Au (˜0.7 Ω/square), and from other related studies on AuNP inks (1.3-3.3 Ω/square for an aqueous-based ink, ˜0.12 Ω/square for a commercial organic-based ink).

The morphology of the printed gold films heated at 50° C. and 400° C. was observed using AFM and FE-SEM (FIG. 5). At 50° C. heating, individual nanoparticles are observed in the film. At this temperature, water was only evaporated leaving the starch-capped nanoparticles in the film. However, the film at this point is already dull gold in color and is already conducting, as shown in the electrical characterization below. The density of the particles in the film is sufficient for tight-packing, as seen in the AFM image, allowing electron mobility across the film. The sizes of the nanoparticles imaged by AFM is larger than those in the FE-SEM (50 nm vs 20 nm), as expected given the difference in the imaging mechanisms. The lateral resolution of AFM is poorer (larger than the true size feature) because of the convolution of the tip shape with the topographical feature. Also, for the non-contact imaging mode done here, which is based on the van der Waals interaction between the tip and surface, the resulting topographical feature includes the starch that remain adsorbed on the gold nanoparticles (prior to sintering) as it is also sensed by the probe tip. In contrast, the SEM image is generated from secondary electrons ejected from the surface which come mostly from high-density atoms such as gold—and thus, the starch (made of lighter atoms, C, H, and O) surrounding the gold nanoparticles would be “invisible” in the SEM image. This is evident in FIG. 5C wherein for some dispersed AuNP, there is noticeable uniform spacings between the spherical nanoparticles in the FE-SEM image, possibly an effect of the starch coating on the nanoparticles. In summary, the AFM shows the complete starch-gold nanoparticle (at a lower lateral resolution) whereas the SEM provides an image only of the gold nanoparticle core with “invisible” starch around it.

After heating at 400° C., starch would be degraded and particles coalesce further together, forming a network of gold aggregates. This is observed in both the AFM and SEM images where bigger particles are mostly present in fused network and are seen embedded in the aggregates. Aside from the increase in particle size, it can also be observed that particle boundaries became less sharp in terms of contrast due to coalescence at these boundaries.

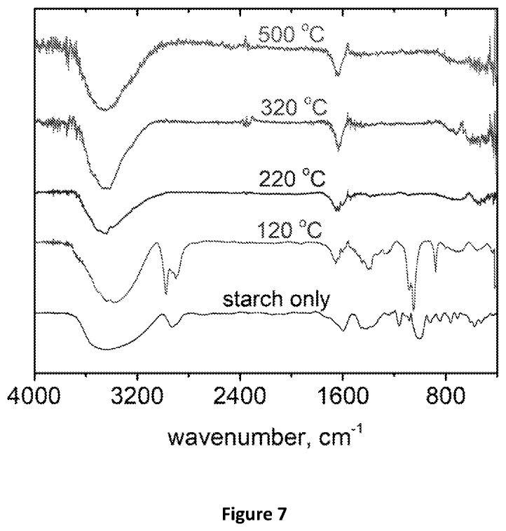

It was also observed that the starch (<2%) on the gold is burned off and not detectable by surface enhance infrared spectroscopy (SEIRA). The samples for FT-IR were prepared by dropping a small volume of the AuNP on KBr powder which was then dried, heated at the indicated temperature in FIG. 7A, and, pelleted. From the ink samples heated at 120° C., IR peaks (in cm⁻¹) for starch (550: pyranose ring skeletal mode; 875: CH₂ deformation; 1080 and 1390: C—O—H bending; 1260: CH₂OH; 2890 and 2980: CH₂ deformation) were observed, as referenced to the IR spectrum of the pure hydrolyzed starch. It is also worth noting that the peaks from the 120° C. sample gave sharper peaks than the pure starch sample, which we mainly attribute to the surface-enhanced IR absorption (SEIRA) of the starch on AuNP surface. Above 200° C., these starch peaks disappeared as expected from the decomposition profile of starch determined through TGA (FIG. 3). Peaks associated to water were still observed due to incomplete drying of the KBr powder. In summary, the IR spectra showed that the starch in the ink degrades at temperatures above 200° C. This should enhance the electrical conductivity of the nanoparticle film upon removal of starch, which is an insulator. Therefore, heating the film to at least 200° C. lowered its sheet resistance, as observed in the electrical characterization of the printed film discussed above.

The following representative examples of performing the process according to the present invention are for purposes of illustration only and are not meant to limit the invention in any way.

### EXAMPLE 1

### Microwave-Assisted Hydrolysis of Starch Solution

Typically, a 4% (w/v) solution of starch (e.g., potato starch from Sigma-Aldrich) was prepared by dissolving the starch in distilled water with gentle heating and stirring either using a hot plate or a kitchen microwave oven with 5-s bursts. This is allowed to cool down to room temperature prior to hydrolysis. For the hydrolysis mixture: equal volumes of the 4% starch solution is mixed with 0.1 M NaOH solution. Using a laboratory microwave reactor (e.g., Milestone flexiWAVE) a temperature program is inputted making sure that the heating is optimized for the volume of solution to be heated. Typically, for a 60-mL reaction volume, the microwave reactor parameters are: 30% stirring speed, 2-min ramp time to target temperature (90° C.), 500 W ramp-power and hold-time of 60 min at 200 W hold-time power. This program yields a fine control of the temperature of the reaction mixture which should aid in producing the optimized sizes of the hydrolyzed starch. This is cooled down to room temperature prior to use in the AuNP synthesis.

### EXAMPLE 2

### Microwave Synthesis of Gold Nanoparticles Using Hydrolyzed Starch and the Ink Preparation

The Au³⁺ precursor solution is a “10% Au precursor” which may be prepared from a gold salt (AuHCl₄) or starting from the pure metal. Starting from the pure metal, 10 g of gold pellets (>98% purity) is dissolved with 60 mL of aqua regia solution which is made up of 1 HNO₃ (r.g.): 3 HCl (r.g.) mixture, done in the fume hood. This mixture in a beaker is heated on a hotplate with stirring at about 80° C. to aid in the dissolution. This step generates brown, toxic NOx gas and so a fume hood is necessary. When the solid gold has completely dissolved, the liquid is allowed to evaporate until the residue almost dry (not completely dry). This residue is then dissolved in 100 mL with deionized (DI) water to produce the “10% Au precursor”.

A 2% Au³⁺ solution with pH 7.0 is prepared from an aliquot of the 10% stock solution wherein a 50% NaOH solution was used to neutralize the aliquot prior to final dilution with distilled, deionized water to make the 2% Au³⁺ final concentration.

Next, equal volumes of the 2% Au³⁺ solution and 0.1 M NaOH are mixed. Using this, and an equal volume of the hydrolyzed starch solution (a freshly hydrolyzed sample as much as possible) is mixed together in a microwave vessel—for a 60-mL reaction mixture, 30 mL of each is mixed. This mixture is then heated uniformly using an optimized microwave heating program to control the temperature profile. For a 60-mL reaction mixture using a Milestone flexiWAVE microwave reactor, the parameters are: 30% stirring speed, 1-min ramp time to reach the target 60° C. temperature at 500 W ramp power, and 15 min hold time at 100 W. This should produce the AuNP solution which is then allowed to cool to room temperature before transferring to a clean container.

To prepare the ink, the AuNP is washed thoroughly with water to remove residues from the microwave synthesis reaction. This was achieved by repeated (at least 2×) washing with distilled, deionized (DI) water with sonication and centrifugation at 13,000 rpm for 15 min. First, the reaction mixture is centrifuged, and the supernatant discarded. The AuNP pellet is dispersed in fresh DI water with ultrasonication at 500 W for 15 min. This is centrifuged again at 13,000 rpm for 15 mins, discarding the supernatant, and fresh DI water added to repeat the washing step above.

Finally, the gold ink is prepared from the washed AuNP, as a concentrated dispersion which is about 1/20th of the original volume from the microwave synthesis reaction step. This AuNP ink is stored in the refrigerator (ca. 4° C.). It remains stable for more than a month.

### EXAMPLE 3

### Inkjet Printing of Starch-AuNP Ink Formulation

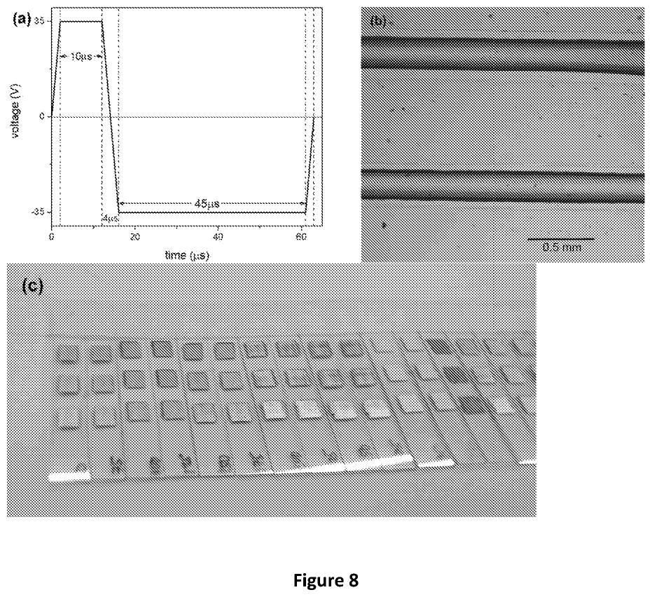

Prepared AuNP inks were filtered first through 0.45 μm membrane prior to loading in an inkjet printer cartridge or ink container. Here, a Jetlab® 4 from MicroFab Technologies, Inc. is used to demonstrate jettability and printability of the ink formulation. A customized bipolar waveform (FIG. 8) was applied to the inkjet nozzle to jet the AuNP ink into single droplets up to 500 Hz jetting frequency. The substrate stage was heated to 50° C. to allow the ink to dry. After printing, it may be sintered on a hotplate at various temperature to improve the conductivity of the printed film.

To minimize the coffee ring effect on the printed film, Triton X-100 is added to the ink formulation to make about 0.3% (w/w). This results in printed gold lines with enhanced fidelity of the print (FIG. 8).

The example illustrates an embodiment of the present invention. Alternative embodiments will suggest themselves to those skilled in the art in light of the above disclosure. It is to be understood, therefore, that changes may be made in the particular embodiments described above which are within the full intended scope of the invention as defined in the appended claims.

What is claimed is:

1. An aqueous monodisperse starch-gold nanoparticle solution having a starch-to-gold mass ratio of less than 2.0 wt %, wherein the stability of the gold nanoparticle as measured by zeta potential is between −32 to −35 mV.

2. The aqueous monodisperse starch-gold nanoparticle solution according to claim 1, wherein the size and size-distribution of the gold nanoparticle as measured by dynamic light scattering is between 40 to 100 nm Z-average.

3. The aqueous monodisperse starch-gold nanoparticle solution according to claim 1, wherein the monodisperse size distribution of the gold nanoparticles is 12% RSD.

4. A process for producing a stable aqueous monodisperse starch-gold nanoparticle solution using a pre-determined molecular weight range of hydrolyzed starch, comprising:
a. hydrolysis of aqueous starch solution using a base in a controlled time and temperature to produce a MW ranging between 1000-1500 kDa,
b. mixing of the hydrolyzed starch in step (a) with an alkaline aqueous Au³⁺ solution, and
c. microwave heating of the mixture in (b) to between 50 to 70° C. for 10 to 20 min.

5. The process according to claim 4, wherein a 4% aqueous solution of starch is hydrolyzed using an equal volume of 0.1 M NaOH and heating in a microwave reactor with stirring and heating from room temperature to a temperature between 85 to 95° C. with a 2-min ramp time, and holding this temperature between 15 to 45 min.

6. The process according to claim 4, wherein the base used is an alkaline solution other than NaOH.

7. The process according to claim 4, wherein step (b) comprises mixing of an equal volume mixture of a 4% hydrolyzed starch produced from the process according to step (a) and a 2% (w/v) alkaline solution of Au³⁺.

8. The process according to claim 4, wherein the alkaline Au³⁺ solution is a 2% (w/w) Au³⁺ mixed with an equal volume of 0.1 M NaOH.

9. The process according to claim 4, wherein the stability of the gold nanoparticle as measured by zeta potential is between −32 to −35 mV.

10. The process according to claim 4, wherein the size and size distribution of the gold nanoparticle as measured by dynamic light scattering is between 40 to 100 nm Z-average.

11. A jettable ink comprising an aqueous monodisperse starch-gold nanoparticle solution having a starch-to-gold mass ratio of less than 2.0 wt %, wherein the stability of the gold nanoparticle as measured by zeta potential is between −32 to −35 mV.

12. The jettable ink according to claim 11, wherein the size and size-distribution of the gold nanoparticle as measured by dynamic light scattering is between 40 to 100 nm Z-average.

13. The jettable ink according to claim 11, wherein the monodisperse size distribution of the gold nanoparticles is 12% RSD.

14. A process for producing a jettable ink comprising:
a. repeated washing with distilled deionized water by ultrasonication in water and centrifugation of a monodispersed starch-gold nanoparticle produced from the process comprising:
a.1 hydrolysis of aqueous starch solution using a base in a controlled time and temperature to produce a MW ranging between 1000-1500 kDa,
a.2 mixing of the hydrolyzed starch in step (a) with an alkaline aqueous Au³⁺ solution, and
a.3 microwave heating of the mixture in (b) to between 50 to 70° C. for 10 to 20 min; and
b. final dilution of the washed gold nanoparticles in water to a desired viscosity between 1.0 to 1.25 cP.

15. The process for producing a jettable ink according to claim 14, wherein a 4% aqueous solution of starch is hydrolyzed using an equal volume of 0.1 M NaOH and heating in a microwave reactor with stirring and heating from room temperature to a temperature between 85 to 95° C. with a 2-min ramp time, and holding this temperature between 15 to 45 min.

16. The process according to claim 14, wherein the base used is an alkaline solution other than NaOH.

17. The process according to claim 14, wherein step (a.2) comprises mixing of an equal volume mixture of a 4% hydrolyzed starch produced from the process according to step (a.1) and a 2% (w/v) alkaline solution of Au³⁺.

18. The process according to claim 14, wherein the alkaline Au³⁺ solution is a 2% (w/w) Au³⁺ mixed with an equal volume of 0.1 M NaOH.

19. The process according to claim 14, wherein the stability of the gold nanoparticle as measured by zeta potential is between −32 to −35 mV.

20. The process according to claim 14, wherein the size and size distribution of the gold nanoparticle as measured by dynamic light scattering is between 40 to 100 nm Z-average.

21. Use of a jettable ink produced from the process according to claim 11 in producing a conducting film, whereby said jettable ink is printed on a substrate using conventional printing means.

22. The use of a jettable ink according to claim 21, wherein the conventional printing means is inkjet printing.

23. A conducting film produced from the use of a jettable ink according to claim 21, said conducting film having a sheet resistance of <1 Ω/square.
